(19) United States
(12) Patent Application Publication
(10) Pub. No.: US 2008/0231634 A1
(43) Pub. Date: Sep. 25, 2008

(54) INTUITIVE MODIFICATION OF VISUAL OUTPUT FROM A MULTI-FUNCTION DISPLAY

(75) Inventors: Mike G. Gyde, Phoenix, AZ (US); Michael J. Stewart, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/689,863

(22) Filed: Mar. 22, 2007

(51) Int. Cl. G06T 15/20

(52) U.S. Cl. 345/427

(57) ABSTRACT

According to an example embodiment, a method for changing the display of a function on a flight deck display having a plurality of non-overlapping display regions comprises the steps of, receiving a first input that identifies the function, receiving a second input that identifies a first display region of the plurality of non-overlapping display regions, and displaying at least a portion of the first function using the first display region in response to receiving the first input and receiving the second input.

### BACKGROUND

1. Technical Field

This disclosure relates generally to display systems, and more particularly to methods and apparatus for intuitively modifying the visual output of a Multi-Function Display (MFD).

2. Description of the Related Art

Present-day avionics displays (and other displays as well) are increasingly growing in size with more flexibility being developed to drive multiple formats. The additional size of display allows more data to be displayed and more powerful avionics drivers provide the means for displaying multiple formats. Although flight decks are becoming more powerful by presenting more data, workload for crewmembers (e.g., pilots, co-pilots, flight engineers, etc.) may be increased due to the burden of managing the wider variety of graphical functions and the appearance of multi-format functions.

According to some conventional techniques, when a crewmember controls a display system to expand the displayed size of a first function on the display screen, the first function is expanded into a predefined area in a predefined location on the display screen. The crewmember typically cannot choose how large to display the expanded first function, or in which location of the display screen the expanded first function is displayed, or both.

According to these conventional techniques, if the crewmember subsequently desired to expand a second function on the display screen after expanding the first function, the crewmember may have to actively control the display system to contract the first function. In other words, the crewmember manipulates the appropriate selection or input devices to select the first expanded function, contract the first function, select the second function, and then finally expand the second function.

In this environment, it would be desirable to have systems, devices, and methods that enable a crewmember to quickly and intuitively manipulate the functions displayed on one or more display screens in order to display a desired function in a desired location of the display screen, and at a desired size. Example embodiments address these as well as other concerns associated with the related art.

### BRIEF DESCRIPTION OF THE DRAWINGS

Example embodiments are described with reference to the following drawings, where like numerals refer to like elements throughout. Furthermore, well-known features that are not necessary for an understanding of the example embodiments are not shown in the drawings in order to increase clarity. In order to emphasize certain features, the drawings may not be to scale.

FIG. 1 is a front-perspective diagram illustrating some components of an example flight control deck that is suitable for implementing example embodiments.

FIG. 2 is a schematic diagram illustrating a default layout for a display screen of FIG. 1 that is suitable for use with example embodiments.

FIG. 3 is a schematic diagram illustrating another default layout for a display screen of FIG. 1 that is suitable for use with example embodiments.

FIGS. 4-17 are schematic diagrams illustrating example layouts for the display screen of FIG. 1 that arise during a series of expansions and contractions of the functions displayed in the default layout of FIG. 2 in accordance with an example embodiment.

FIG. 18 is a block diagram illustrating some components of a flight control system that is suitable for implementing example embodiments.

FIG. 19 is a flow diagram illustrating some of the processes included in a method of changing the size of a functional display on a flight control display screen in accordance with an example embodiment.

### DETAILED DESCRIPTION

The example embodiments described below are specifically directed at the manipulation of aircraft related data or aircraft related functions that are typically displayed on a display screen in an aircraft. However, after reviewing the example embodiments described below, those of skill in the art will recognize that one or more of the inventive aspects could easily be incorporated into systems besides aircraft-based systems. Display screens are also widely used for the monitoring and control of mobile or fixed land-based systems that include, but are not limited to, security systems, entertainment systems, communication systems, control systems, power management systems, and tracking systems such as an air traffic control systems.

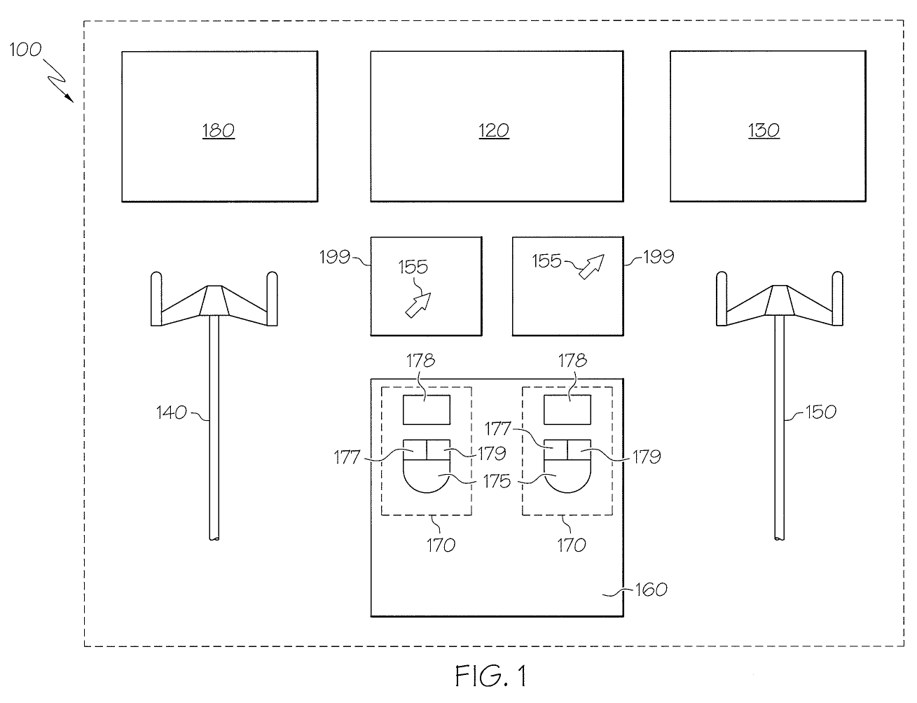

FIG. 1 is a block diagram that illustrates some components of an example flight control deck 100 that is suitable for use with example embodiments. While FIG. 1 is not drawn to scale, and illustrates only a few components that would otherwise be present in an actual flight control deck, nevertheless it should be readily apparent that that the example flight control deck 100 would be suitable for use by two pilots sitting in a side-by-side configuration in an aircraft cockpit.

The flight control deck 100 includes a left Multi-Function Display (MFD) 180, a center MFD 120, a right MFD 130, and two display screens 199 arranged in a side-by-side configuration. The flight control deck further includes a middle console 160 disposed between a left control yoke 140 and a right control yoke 150. The middle console 160 includes two Cursor Control Devices (CCDs) 170 arranged below the display screens 199.

The CCDs 170 include two components, a handrest 175 and a touchpad area 178. By touching the touchpad area 178, the pilot can control the movement of a cursor 155 that is displayed in the display screen 199. The handrests 175 include a left select pad 177 and a right select pad 179, which, when depressed, may select a display region of the display screen where the cursor is displayed, may cause a drop-down menu to appear at a location where the cursor is displayed, or may select a function that currently displayed in the display screen. In alternative embodiments, the CCDs 170 may include a touchpad area, and not a handrest. Other CCDs that are suitable for use with example embodiments include a joystick, a mouse, or a stimuli-sensitive display screen that responds to touch or some other physical manipulation of the screen. There are many known ways to control a cursor for the selection of various functions displayed on a display screen, display regions of a display screen, or alternatives displayed in different lists or menus, and example embodiments are suitable for use with all of them. Generally speaking, the CCD 170 and other alternative devices for that enable a crewmember to make selections to control the layout of the display screen (e.g., generate inputs) may be referred to as a user interface.

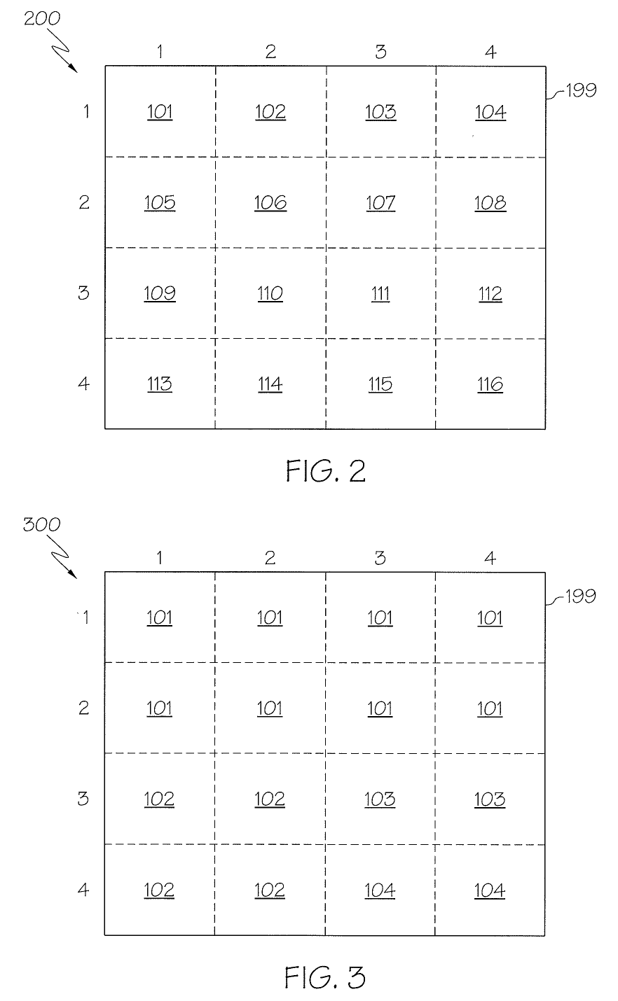

FIG. 2 is a schematic diagram illustrating a default layout 200 for the display screen 199 that is suitable for use with example embodiments. The default layout 200 is an arbitrary example of how different functions might be displayed on the display screen 199 at a particular time—for example, upon startup of the aircraft. In FIG. 2, the display screen 199 has four rows 1-4 and four columns 1-4 that define sixteen distinct display regions of the display screen. Each of the sixteen display regions may be specified by identifying the particular row and column of the display screen 199. For example, the display region in the upper left corner of display screen 199 is identified as the display region occupying row 1, column 1 or display region (1, 1). Similarly, the display region in the lower right corner of the display screen 199 is display region (4, 4).

According to some embodiments, the size, shape, or both the size and shape of the display regions in the display screen 199 are not uniform. In preferred embodiments, however, such as the ones illustrated in FIG. 2 and FIG. 3, the display regions have a substantially uniform size and shape. Furthermore, in more preferred embodiments, such as the ones illustrated in FIG. 2 and FIG. 3, each of the display regions has four (4) ninety degree angles. That is, according to more preferred embodiments the display regions are uniformly square or uniformly rectangular.

Although the display screen 199 is divided into a (4×4) grid of four rows and four columns (4×4) to create sixteen display regions, in example embodiments the display screen 199 could theoretically be divided into any suitable number of M rows and N columns to create a (M×N) grid of (M×N) display regions, where M and N are variable. Practically speaking, however, the values of M and N are limited based upon an overall dimension of the display screen 199 and a predetermined minimum size for each one of the display regions in the display screen.

In the default layout 200, each one of the display regions is used to display one of sixteen functions 101-116. That is, each one of the functions 101-116 is displayed using one of the display regions. The layout 200 is therefore representative of the maximum number of functions that could be displayed at any particular time in a (4×4) grid having sixteen display regions.

In other default layouts of the display screen 199, the number of functions that are displayed may be less than the number of display regions in the display screen. For example, FIG. 3 is a schematic diagram illustrating another example default layout 300 for the display screen 199 that is suitable for use with example embodiments. The default layout 300 is an arbitrary example of how different functions might be displayed on the display screen 199 at a particular time—for example, upon startup of the aircraft.

Like default layout 200, default layout 300 has the same display regions that are arranged in a 4×4 grid across the display screen 199. However, the default layout 300 only displays four of the functions 101-104 that are displayed in layout 200. In default layout 300, function 101 is displayed using an area of display screen 199 that is eight times greater than in default layout 200, and function 102 is displayed in an area that is four times greater than in default layout 200. Default layout 300 displays functions 103 and 104 in areas that are twice as large as default layout 100.

The preceding paragraph, which identifies differences between default layouts 200 and 300, illustrates a concept that should be kept in mind throughout this disclosure. The concept is that when the same function appears in adjacent display regions of the display screen 199, it does not mean that the function is reproduced separately in each of the adjacent display regions. Rather, it indicates that the function is displayed in a single area that is equal to the sum of the areas of the adjacent display regions. Thus, in default layout 200, function 101 is displayed using only one display region (1, 1), while in default layout 300, function 101 is displayed using eight display regions (1, 1), (1, 2), (1, 3), (1, 4), (2, 1), (2, 2), (2, 3), (2, 4). In default layout 300, function 101 is therefore displayed eight times larger than in default layout 200.

The particular function that is implemented in each of the distinct regions of display screen 199 for the default layouts 200 and 300 is not necessary for an understanding of the example embodiments, as there are many different functions that exist as potential candidates. One of the functions 101-116 may be, for example, an altimeter. Another one of the functions 101-116 may be, for example, a heading indicator. Still another one of the functions 101-116 may be a fuel status indicator. Yet another one of the functions 101-116 may be a radio status indicator/controller. Each of the functions 101-116 may be any distinct function that is used for aircraft monitoring and control or aircraft sub-system monitoring and control.

Furthermore, the exact appearance of each one of the functions 101-116 is also not necessary for an understanding of the example embodiments, as these details may vary widely for each one of the functions. For example, one of the functions 101-116 may be an altimeter function. In one particular implementation of an altimeter function, a simple digital readout that is representative of the current aircraft altitude may be utilized. In another implementation of the altimeter function, a representation of the older “clock-style” altimeter that indicates the current altitude using a rotating hand and a dial may be displayed. There is a practically an endless variety of ways to display any particular function using different combinations of text, symbols, colors, etc.

The display screen 199 that is illustrated in FIG. 1 may be part of a number of different display devices that generate visual output on the display screen using one of many different technologies. For example, the display screen 199 may be part of a color Cathode Ray Tube (CRT) display device, a monochromatic CRT display device, a flat panel display device, a Liquid Crystal Display (LCD) device, a plasma display device, an electro-luminescent display device, a micro-mirror display device, a Light Emitting Diode (LED) display device or the like.

The display screen 199 may also be sensitive to external stimuli. For example, the display screen 199 may be operable to produce a signal when it is contacted with an object, when an object is within a certain proximity to the display screen, or when the display screen is exposed to a light, such as a laser pointer. Detailed functional descriptions of these identified examples of display screens or display devices or other unidentified examples are not necessary as they can be found elsewhere in the literature and are not required for an understanding of example embodiments.

Returning to FIG. 1, by depressing the left select pad 177 or the right select pad 179 of the CCDs 170 when the cursor 155 is in a selected area of the display screen 199, the pilot can select one of the functions that are displayed on the display screen 199. For example, referring to the default layout 200, the pilot can select function 111 as the active function by placing the cursor 155 in display region (3, 3) and depressing the left select pad 177. The pilot may also select one of the display regions of the display screen 199 in a similar manner. For example, referring to the default layout 200, the pilot can select display region (2, 4) by placing the cursor 155 in the display region (2, 4) and depressing the right select pad 179. It should be apparent that CCDs 170 may alternatively be used to select functions or display regions in other displays in the aircraft, such as MFDs 180, 120, or 130.

There are many other ways to select an active function on the display screen 199 or a display region of the display screen 199 in a flight control environment. For the example flight deck 100 described above, the process of selecting an active function or a display region on the display screen 199 using the cursor 155 and the CCDs 170 is very similar to using a mouse to control a cursor on a desk-top computer. As another example, if the display screen 199 were a touch-sensitive display screen, a pilot could select an active function on the display screen or a display region of the display screen by touching the appropriate area of the display screen. As another example, there may be small buttons (not shown) arranged around the edges of the display screen 199. By depressing a first button arranged along a first edge, and then a second button arranged along a second edge that is perpendicular to the first edge, the pilot could also select an active function of the display screen 199 or a display region of the display screen. Example embodiments are intended to be compatible with any known method of selecting an active function on the display screen 199 or any known method of selecting a display region on the display screen 199.

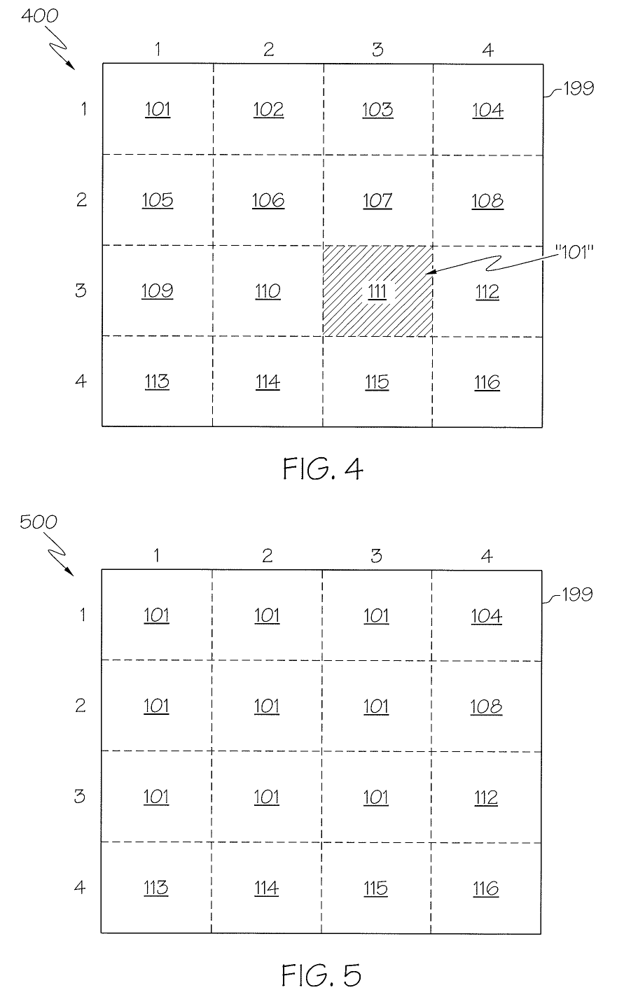

An appropriate way to illustrate an example embodiment is to present an example series of manipulations of the functions displayed on the display screen 199, starting from the initial default layout 200 of FIG. 2. FIGS. 4-17 are schematic diagrams illustrating example layouts for the display screen that arise during an example series of expansions and contractions of the functions displayed in the default layout 200 in accordance with an example embodiment. Of course, there are many possible variations in how the displayed functions of default layout 200 may be expanded and contracted. Still, the principles and teachings illustrated by the example series will apply with equal force to these variations.

For purposes of this disclosure, the words “contracted,” “contracting,” “contraction,” and “contract” are used to refer to a function that is displayed on the current display screen layout but is reduced in size relative to a previous display screen layout. For purposes of this disclosure, the words “expanded,” “expanding,” “expansion,” and “expand” are used to refer to a function that is displayed on the current display screen layout but is enlarged in size relative to a previous display screen layout. For purposes of this disclosure, the words “added,” “adding,” “addition,” and “add” are used to refer to a function that is displayed on the current display screen layout but was absent from a previous display screen layout. For purposes of this disclosure, the words “subtracted,” “subtracting,” “subtraction,” and “subtract” are used to refer to a function that is absent from the current display screen layout but was displayed on a previous display screen layout.

Referring to FIG. 4, the example layout 400 for the display screen 199 is the same as the default layout 200. That is, the functions displayed in layout 400 are the same as those displayed in default layout 200. In layout 400, display region (3, 3) shows cross-hatching, and the arrow pointing to display region (3, 3) that is labeled “101” points to the display region (3, 3). The cross-hatching in display region (3, 3) is for illustrative purposes only, and indicates that display region (3, 3) was selected by the crewmember using a user interface, for example, the cursor 155 and the CCD 170 of FIG. 1. Furthermore, the arrow labeled “101” is for illustrative purposes only, and indicates that the function 101 was selected by the crewmember using a user interface, for example, the cursor 155 and the CCD 170 of FIG. 1. In effect, the cross-hatching and arrow illustrated in FIG. 4 is indicative that that the crewmember has selected function 101 and the display region (3, 3).

The crewmember's selection of the display region (3, 3) and the selection of the function 101 with the user interface produces a first input signal that identifies at least the display region (3, 3) and a second input signal that identifies at least the function 101 as the active function. A display system that includes the display screen 199 is operable to receive the first input signal and the second input signal. Based at least in part upon the first and second input signals, the display screen 199 is operable to change the functions that are displayed in layout 400 to the functions that are displayed in layout 500 of FIG. 5.

As illustrated in layout 500, the function 101 is expanded to include nine display regions, or display regions (1, 1), (1, 2), (1, 3), (2, 1), (2, 2), (2, 3), (3, 1), (3, 2), (3, 3). The display region (3, 3) that was initially selected by the crewmember now occupies one corner of the enlarged area that is now used to display expanded function 101. In layout 500, the functions 102, 103, 105, 106, 107, 109, 110, and 111 are subtracted relative to layout 400.

Alternatively, according to the example embodiment, the crewmember could have selected function 101 as the active function and any other display region in the display screen 199 and the function 101 would be expanded such that selected display region occupies at least one corner of the expanded function. For example, if function 101 and display region (1, 4) had been selected, function 101 would have been expanded to occupy all the display regions in row 1 of the display screen 199. As another example, if function 101 and display region (4, 1) had been selected, function 101 would have been expanded to occupy all the display regions in column 1 of the display screen 199. As yet another example, if function 101 and display region (4, 4) had been selected, function 101 would have been expanded to occupy all sixteen display regions in display screen 199. In all these alternative selections, function 101 would be expanded such that the display region identified by the crewmember defines at least one corner of the expanded function.

According to the example embodiment, a function can be displayed using any one of the sixteen display regions. According to the example embodiment, a function can also be displayed using all of the sixteen display regions. In some example embodiments, there may be display regions of the display screen 199 that are dedicated—that is, the display region can only be used to display one particular function. While the presence of dedicated display regions may limit the number of ways that a function can be expanded, these embodiments are still a significant improvement over conventional techniques where there is only one pre-defined way in which a function can be expanded.

The change from layout 400 to layout 500 illustrates a first principle of the example embodiment. One verbal formulation of the first principle is that the selected display region is used to add or expand the active function in the layout of the display screen. When a function is expanded, there may be other, unselected display regions that are used to expand the function as well. This is seen in the transition from layout 400 to layout 500, where in addition to the selected display region (3, 3), the display regions (1, 2), (1, 3), (2, 1), (2, 2), (2, 3), (3, 1), and (3, 2) are also used to expand the function 101.

The change from layout 400 to layout 500 further illustrates a second principle of the example embodiment. One verbal formulation of the second principle is that each displayed function in the display screen 199 can be displayed either in a single display region or in a single group of adjacent display regions that maintains the overall shape of a single display region.

In this case, although function 101 is initially displayed in layout 400 using one display region (1, 1), the function cannot remain solely in display region (1, 1) in layout 500 because this would violate the first principle of using the selected display region to add or expand the selected function. To satisfy the second principle, the function 101 is expanded so that it occupies the nine display regions as shown in layout 500, which is a single group of adjacent display regions that maintains the overall shape of a single display region. That is, the area occupied by function 101 in layout 400 has four ninety degree angles, and the area occupied by function 101 in layout 500 also has four ninety degree angles. Thus, the overall rectangular (or alternatively, square) shape of function 101 is maintained from layout 400 to layout 500.

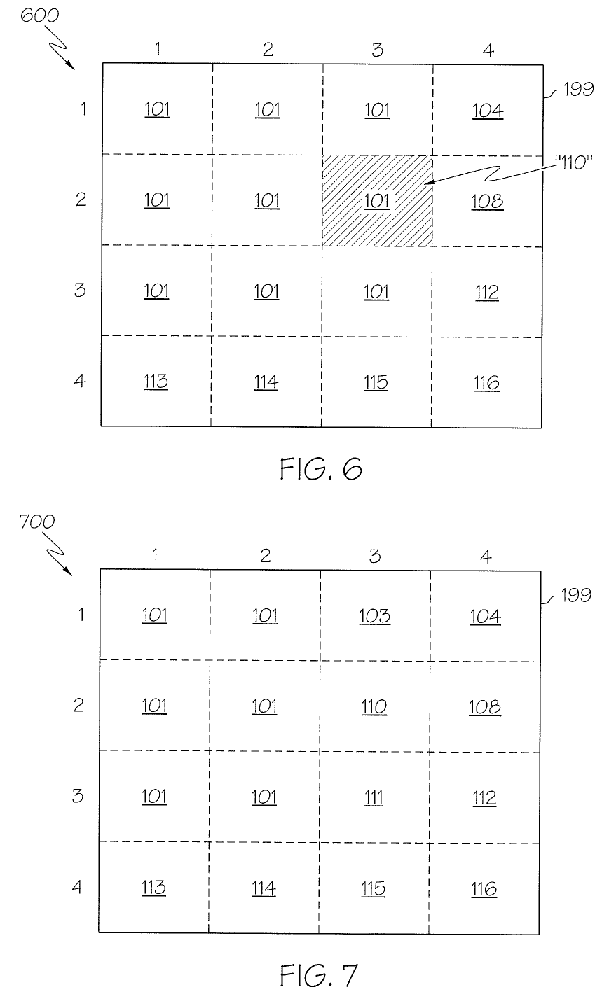

Moving on to FIG. 6, the layout 600 is the same as layout 500, but the cross-hatching in display region (2, 3) and the arrow pointing the display region (2, 3) that is labeled “110” indicate that the crewmember has now selected function 110 to be displayed in the display region (2, 3). In this case, the selection of function 110 is somewhat different than the selection of function 101 as illustrated in FIG. 4, because function 110 is not displayed in layout 600.

According to the example embodiment, any of the functions 101-116 from the default layout 200 may be selected as the active function, regardless of whether the function is currently displayed in the current layout or not. There are a number of ways that a non-displayed function could be selected. For example, a drop-down menu may appear on the display screen 199 in response to depressing the right select pad 179 on the handrest 175. The drop-down menu may include a listing of the functions that are not displayed in layout 600, or alternatively the drop-down menu may include a listing of all the functions 101-116. By manipulating the user interface, for example, by moving the cursor 155 using the touchpad 178, the crewmember could then select the desired non-displayed function. Other methods for selecting a non-displayed function will be apparent to those skilled in the art, and all known methods are suitable for use with example embodiments.

The crewmember's selection of the display region (2, 3) and the selection of the function 110 produces a first input signal that identifies at least the display region (2, 3) and a second input signal that identifies at least the function 110. A display system that includes the display screen 199 is operable to receive the first input signal and the second input signal. Based at least in part upon the first and second input signals, the display screen 199 is operable to change how the functions are displayed in layout 600 to the layout 700 of FIG. 7.

As illustrated in layout 700, function 110 is added in display region (2, 3), which is in keeping with the first principle that was described above. Because of the introduction of function 110 in display region (2, 3), function 101 can no longer be displayed in display regions (1, 3) or (3, 3), which would be a violation of the second principle that was described above. Thus, because of the new presence of function 110 in display region (2, 3), function 101 is contracted to comply with the second principle.

There are several ways in which function 101 may be contracted that would result in an overall rectangular (or square) shape for function 101. As illustrated in layout 700, one option (and the correct one) is to contract function 101 into the six display regions (1, 1), (1, 2), (2, 1), (2, 2), (3, 1), and (3, 2). A second option is to contract function 101 into the first three display regions of row 1, which are display regions (1, 1), (1, 2), and (1, 3). A third option is to contract function 101 into the first three display regions of column 1, which are the display regions (1, 1), (2, 1), and (3, 1).

The contraction of function 101 into the six display regions as illustrated in FIG. 6 and FIG. 7 is illustrative of a third principle of the example embodiment. One verbal formulation of the third principle is that the contraction of a previously expanded function should be done in such a way as to maximize the previously expanded function. Thus, according to the third principle, function 101 is contracted into the six display regions as shown in FIG. 7 because that is the choice that maximizes the area of function 101—six display regions are greater than the three display regions of the other two options.

As a result of the contraction of function 101 from the display regions (1, 3), (2, 3), and (3, 3), it is also determined which functions are displayed in display regions (1, 3) and (3, 3). The display region (2, 3) is already accounted for under the first principle—the crewmember requested that function 110 be displayed in display region (2, 3). However, none of the first three principles explains why layout 700 uses the display regions (1, 3) and (3, 3) to add functions 103 and 111, respectively.

The explanation illustrates the operation of a fourth principle of the example embodiment. One verbal formulation of the fourth principle is that when an expanded function that occupies a display region is contracted and no longer occupies the display region, the function that should then be displayed in the display region is the default function for the display region. The default layout 200 of FIG. 2 illustrates that the default functions for display regions (1, 3) and (3, 3) are the functions 103 and 111. Thus, those are the functions that are used in the display regions (1, 3) and (3, 3) of layout 700.

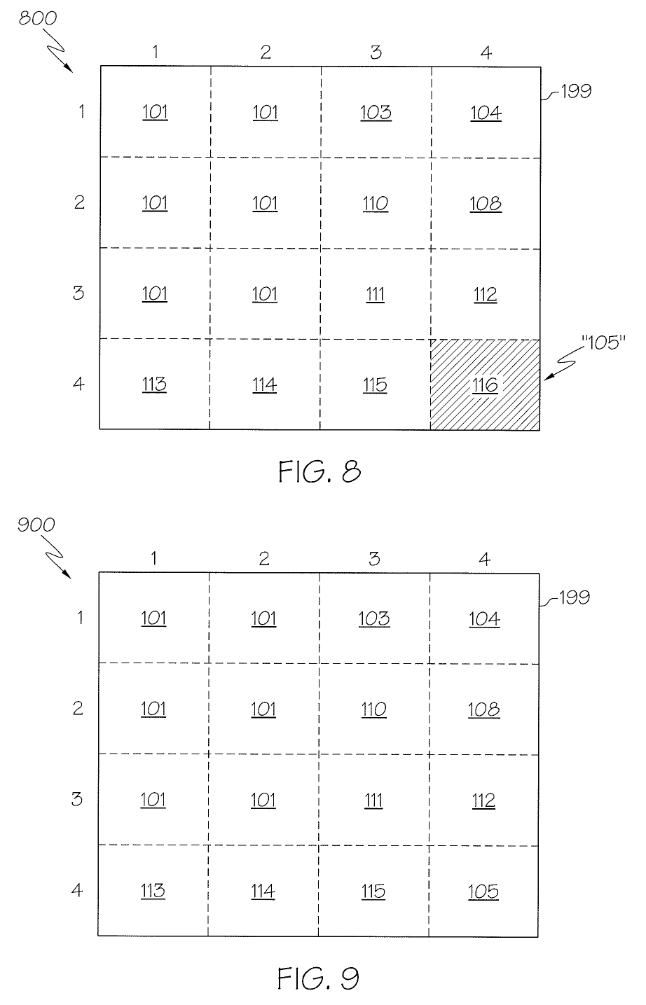

Moving on to FIG. 8, the layout 800 is the same as layout 700, but the cross-hatching in display region (4, 4) and the arrow pointing to the display region (4, 4) that is labeled “105” indicate that the crewmember has now selected function 105 to be displayed in the display region (4, 4). The crewmember's selection of the display region (4, 4) and the selection of the function 105 produces a first input signal that identifies at least the display region (4, 4) and a second input signal that identifies at least the function 105. A display system that includes the display screen 199 is operable to receive the first input signal and the second input signal. Based at least in part upon the first and second input signals, the display screen 199 is operable to change the functions as displayed in layout 800 to the layout 900 of FIG. 9.

As illustrated in layout 900 of FIG. 9, function 105 is added in display region (4, 4), and function 116 is subtracted, in accordance with the first principle that can be stated as the crewmember gets what is requested. The second principle is also satisfied, as function 105 is displayed in a single display region (4, 4). The third principle is not implicated, as the addition of function 105 to display region (4, 4) does not affect a displayed function that was previously expanded. The fourth principle is also not implicated, as there are no display regions that need to be filled because of the contraction of a previously displayed function.

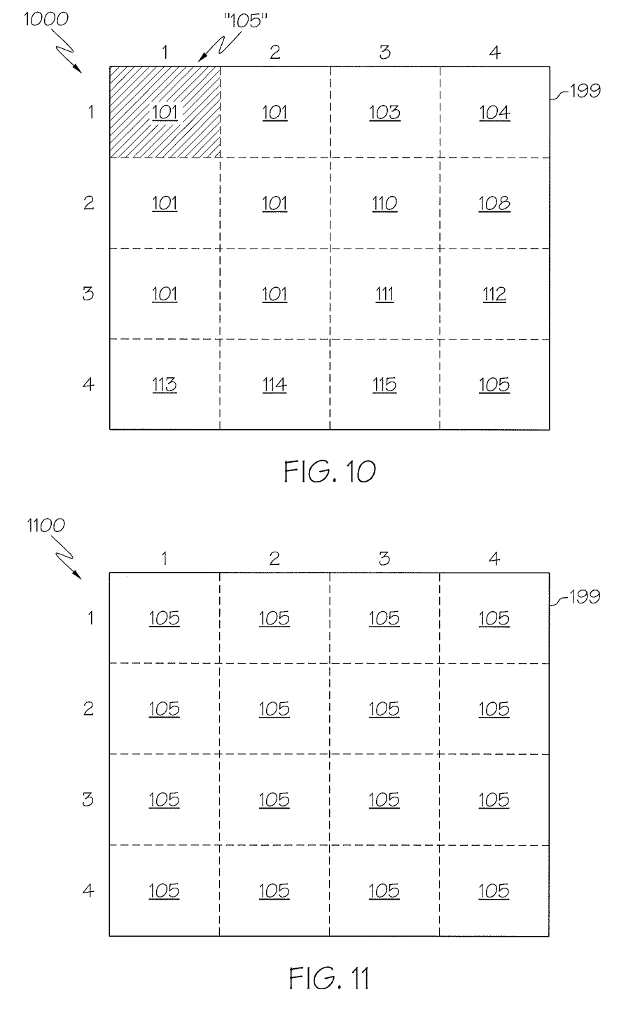

Moving on to FIG. 10, the layout 1000 is the same as layout 900, but the cross-hatching in display region (1, 1) and the arrow pointing to the display region (1, 1) that is labeled “105” indicate that the crewmember has now selected function 105 to be displayed in the display region (1, 1). The crewmember's selection of the display region (1, 1) and the selection of the function 105 produces a first input signal that identifies at least the display region (1, 1) and a second input signal that identifies at least the function 105. A display system that includes the display screen 199 is operable to receive the first input signal and the second input signal. Based at least in part upon the first and second input signals, the display screen 199 is operable to change the functions as displayed in layout 1000 to the layout 1100 of FIG. 11.

As illustrated in layout 1100 of FIG. 11, function 105 is displayed in the display region (1, 1) in accordance with the first principle of using the selected display region to add or expand the active function. The second principle is also satisfied, as function 105 is expanded into a single group of adjacent display regions that maintains the overall shape of a single display region. In this case, the single group of adjacent display regions happens to be all sixteen of the display regions in the display screen 199.

The expansion of function 105 as shown in FIGS. 10 and 11 shows how any function that is displayed in a corner of the display screen 199 may be expanded to fill the entire display screen 199 in accordance with the example embodiment—through the selection of the function and the display region in the opposite corner of the display screen from the selected function. In layout 1100, the third and fourth principles do not operate as there are no remaining display regions left to fill after function 105 is expanded in accordance with the first and second principles—all other functions are subtracted from the display screen 199.

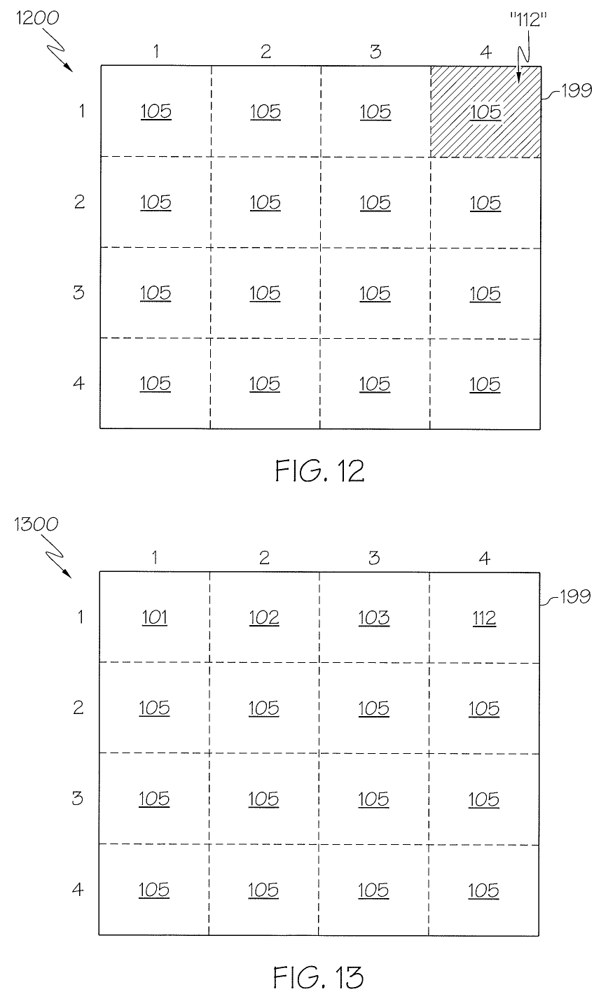

Moving on to FIG. 12, the layout 1200 is the same as layout 1100, but the cross-hatching in display region (1, 4) and the arrow pointing to display region (1, 4) that is labeled “112” indicate that the crewmember has now selected function 112 to be displayed in the display region (1, 4). The crewmember's selection of the display region (1, 4) and the selection of the function 112 produces a first input signal that identifies at least the display region (1, 4) and a second input signal that identifies at least the function 112. A display system that includes the display screen 199 is operable to receive the first input signal and the second input signal. Based at least in part upon the first and second input signals, the display screen 199 is operable to change the functions as displayed in layout 1200 to the layout 1300 of FIG. 13.

As illustrated in layout 1300 of FIG. 13, function 112 is added to the display region (1, 4) in accordance with the first principle of using the selected display region to add or expand the active function. The function 112 in display region (1, 4) also satisfies the second principle because the function is displayed in a single display region.

There are two possible ways in which function 105 can be contracted in accordance with the second and third principles. That is, function 105 could be contracted to occupy the twelve display regions of the first three columns (columns 1, 2, 3). Alternatively, function 105 could be contracted to occupy the twelve display regions of the last three rows (rows 2, 3, and 4). Of course, the configuration illustrated in FIG. 13 is the correct one, where the function 105 is contracted to occupy the twelve display regions in the last three rows. The reason why the illustrated configuration is correct is because the default functions 101, 102, and 103 can be added to display regions (1, 1), (1, 2), and (1, 3), respectively, in accordance with the fourth principle, without violating any of the other three principles. Conversely, if function 105 were contracted into the first three columns of the display screen 199, application of the fourth principle would cause function 112 to be added to the display region (3, 4) as well as the display region (1, 4), and this would be a violation of the second principle because the display regions (1, 4) and (3, 4) do not constitute a single group of adjacent display regions that maintain the overall shape of a single display region.

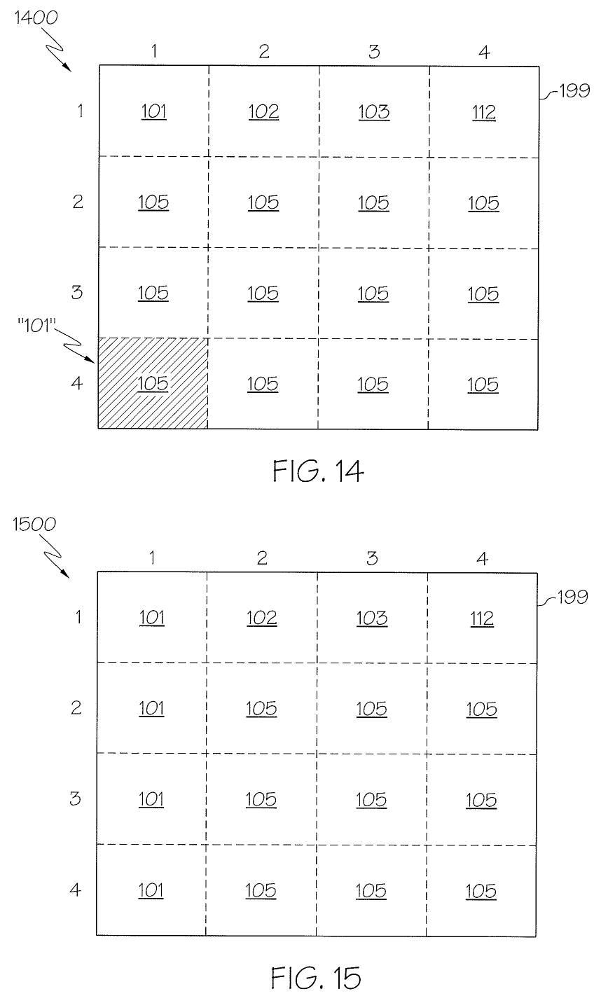

Moving on to FIG. 14, the layout 1400 is the same as layout 1300, but the cross-hatching in display region (4, 1) and the arrow pointing to display region (4, 1) that is labeled “101” indicate that the crewmember has now selected function 101 to be displayed in the display region (4, 1). The crewmember's selection of the display region (4, 1) and the selection of the function 101 produces a first input signal that identifies at least the display region (4, 1) and a second input signal that identifies at least the function 101. A display system that includes the display screen 199 is operable to receive the first input signal and the second input signal. In response to at least the first and second input signals, the display screen 199 is operable to change the functions as displayed in layout 1400 to the layout 1500 of FIG. 15. The expansion of function 101 from the display region (1, 1) in layout 1400 to occupy the first column of the display screen 199 as shown in layout 1500 is easily predicted based upon a straightforward application of the first and second principles that were described above.

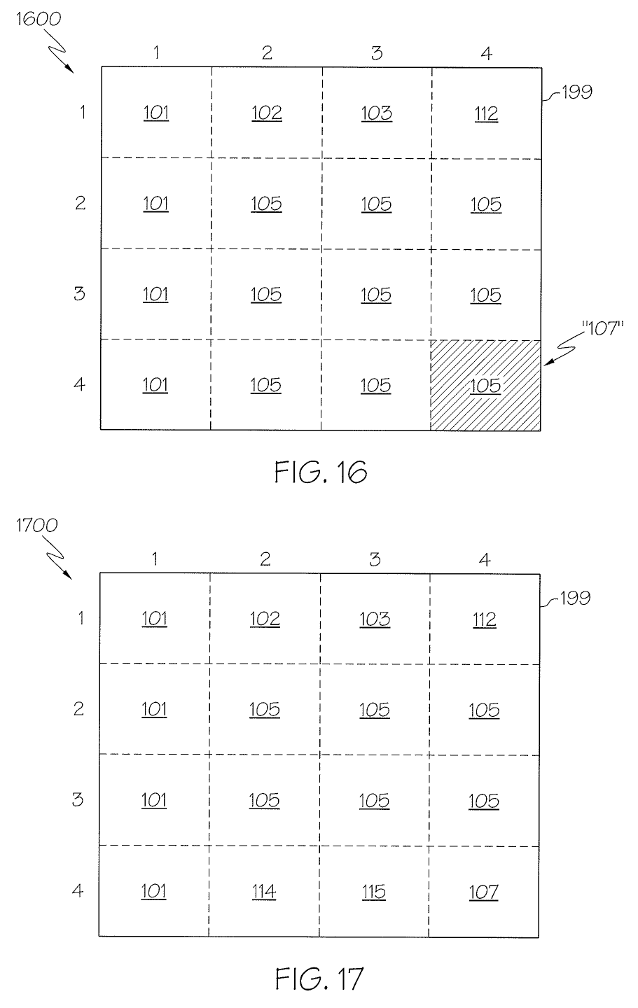

Referring now to FIG. 16, the layout 1600 is the same as layout 1500, but the cross-hatching in display region (4, 4) and the arrow pointing to display region (4, 4) that is labeled “107” indicate that the crewmember has now selected function 107 to be displayed in the display region (4, 4). The crewmember's selection of the display region (4, 4) and the selection of the function 107 produces a first input signal that identifies at least the display region (4, 4) and a second input signal that identifies at least the function 107. A display system that includes the display screen 199 is operable to receive the first input signal and the second input signal. In response to at least the first and second input signals, the display screen 199 is operable to change the functions as displayed in layout 1600 to the layout 1700 of FIG. 17.

The transition between layout 1600 and layout 1700 is very similar to the transition between layout 1200 and layout 1300 that was described above. In this case function 105 may be contracted into the six display regions (2, 2), (2, 3), (2, 4), (3, 2), (3, 3), and (3, 4) as shown in layout 1700, without violation of any of the four principles that were previously described.

However, one will notice that function 105 might alternatively have been contracted into the six display regions (2, 2), (2, 3), (3, 2), (3, 3), (4, 2) and (4, 3) without violating any of the four principles. Unlike the transition between layouts 1200 and 1300, the contraction of function 105 from the display regions (2, 4) or (4, 2) would not result in function 107 being added to the display regions (2, 4) or (4, 2), which is a violation of the second principle.

Therefore, the transition between layout 1600 and 1700 as shown in FIGS. 16 and 17 illustrates a fifth principle of the example embodiment. One verbal formulation for the fifth principle is that if it is possible to contract a function in two different ways without violating the first, second, third, or fourth principles, the alternative that maximizes the horizontal direction of the function is preferred. Thus, as illustrated in layout 1700, function 105 is contracted so that it is three display regions wide rather than three display regions tall. In alternative embodiments, preference may be given to alternatives that maximize the vertical direction. As those of ordinary skill will recognize, there are many criteria that could be used to choose between two or more alternatives, and alternative example embodiments could use any combination of criteria to choose between the alternatives.

At this point, one last scenario that does not result in any changes to the displayed functions will be described using the layout 1700 of FIG. 17. Suppose that function 105 had been previously selected as the active function, and further suppose that the crewmember (perhaps mistakenly) selected display region (3, 3) as the display region to add or expand function 105 into. As shown in layout 1700, the display region (3, 3) is already being used to display an expanded function 105, so the first principle is satisfied. The second principle is also satisfied, as function 105 is already being displayed in a single group of adjacent display regions that maintains the overall shape of a single display region. No contraction of function 105 is necessitated as a result of placing function 105 in display region (3, 3), so the third principle does not come into play, nor does the fourth or fifth principles. Thus, the overall appearance of layout 1700 remains unchanged if the crewmember purposely or mistakenly selects a function and a display region that was already being used to display the selected function.

In the description presented above, five principles of the example embodiment were explicitly identified. In Table I, which appears below this paragraph, these principles are summarized in the order in which they were presented.

TABLE I

| Principle | Verbal Formulation |
|---|---|
| 1 | The selected display region is used to add or expand the |
| | active function in the layout of the display screen. |
| 2 | Each function is displayed either in a single display region |
| | or in a single group of adjacent display regions that |
| | maintains the overall shape of a single display region. |
| 3 | The contraction of a previously expanded function should |
| | be done in a way that maximizes the function. |
| 4 | When a previously expanded function is contracted from a |
| | display region, the function that is displayed in the display |
| | region is the default function for the display region. |
| 5 | If a function may be contracted two different ways without |
| | violating the other principles, the alternative that |
| | maximizes the horizontal direction is preferred. |

The order in which the five principles were presented in the above description was not random, ordering the principles in this manner is a convenient and logical way to describe example embodiments. However, by ordering the principles in this manner it should not be inferred that one principle takes priority over any of the others. The first and second principles apply to every possible scenario, while the third, fourth, and fifth principles might be applicable when a contraction of a function occurs as a result of an expansion. For each of the manipulations that are illustrated in FIGS. 4-17, the result can be predicted by the consistent application of every applicable principle.

Although five principles of the example embodiment were explicitly described, this should not be construed to suggest that all example embodiments must exhibit every one of these principles. Rather, example embodiments may exhibit one or more of these principles.

Furthermore, care was taken to suggest, and here it is definitively stated, that there may be more than one verbal formulation for each of the five principles. It should be self-evident that several functionally equivalent ways of expressing or describing the same principle or idea may exist.

Lastly, the fact that only five principles were explicitly described should not be taken to mean that the example embodiments are limited to only five principles. There may be other principles that are implicit or inherent to the example embodiments as described above. It is also conceivable that any one of the five principles described above could be decomposed into two or more separate principles, or alternatively be combined with another one of the five principles to arrive at less than five principles.

In the series of manipulations illustrated in FIGS. 4-17 and described above, any expansion or addition of a function to the display screen that was specifically requested by the crewmember through the manipulation of the user interface resulted in a contraction or subtraction of another function from the display screen. According to the series of manipulations, any contraction or subtraction that was necessary was performed automatically, as a result of the crewmember's selection of a function to add or expand. Thus, example embodiments provide a much more direct and intuitive approach to changing the size of a function compared to conventional techniques where a crewmember actively controls the contraction or subtraction of unwanted functions before expanding or adding the function she wants to expand or add to begin with. According to example embodiments, the crewmember may simply select a function and a display region, which can be associated with the mental process of thinking “I want this (function) displayed here (display region).”

The series of manipulations that were illustrated in FIGS. 4-17 and explained above were purposely chosen to illustrate some of the more difficult situations that arise in the application of the described principles. Most other examples are more straightforward. Regardless, consistent application of the principles that were described above provide a intuitive and predictable way to adjust the layout of functions on a display screen with a minimum increase to crewmember workload.

In fact, the inventors have found that crewmembers who use a display system that operates in accordance with the example embodiment described above rapidly achieve a level of proficiency where any manipulation of a function size or display format becomes second nature, requiring very little active thought. At a minimum, this level of proficiency can be achieved with a basic knowledge of the default layout and the ability to select a function and a particular display region of the display screen. The example embodiments described above removed any need for the crewmember to actively select and contract or select and subtract functions that are no longer wanted, significantly reducing crewmember workload. Furthermore, according to the example embodiments described above, the crewmember is not limited to one predefined way of displaying an expanded function.

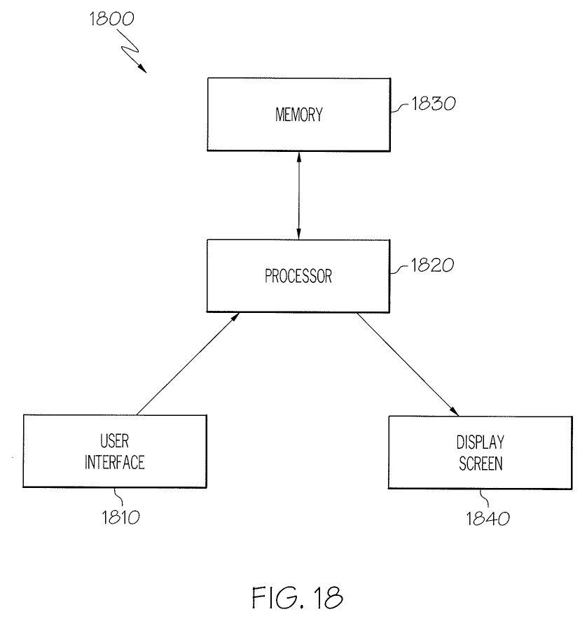

FIG. 18 is a block diagram illustrating some components of a flight control system 1800 that is suitable for implementing example embodiments. The flight control system 1800 includes a user interface 1810, a processor 1820, a memory 1830, and a display screen 1840. The display screen 1840 may be, for example, the display screen 199 that was illustrated in FIGS. 1-17. In alternative embodiments, the display screen 1840 may be one of the other display screens of the example flight control deck 100 of FIG. 1. That is, the display screen 1840 may be display screen 180 of FIG. 1, display screen 120 of FIG. 1, or display screen 130 of FIG. 1.

The processor 1820 is operable to control the display screen 1840 in order to generate one or more functions in the display regions of the display screen. The processor 1820 preferably encompasses one or more functional blocks and can include any number of individual microprocessors, memories, storage devices, interface cards, or other processor components.

The processor 1820 is further operable to receive signals from the user interface 1810. The signals received may include a first signal that is indicative of a selected one of a plurality of default functions. The signals may further include a second signal that is indicative of a selected display region of the display screen. Based at least in part upon the second signal, the processor 1820 is further operable to change the size of the selected function on the display screen 1840, in keeping with the example embodiment described above.

According to example embodiments, the user interface 1810 may include any number or combination of the following devices: a CCD, for example, the CCD 170 of FIG. 1, a mouse, a touchpad, a keyboard, a laser pointer, buttons, switches, joysticks, a throttle for an aircraft, a control yoke for an aircraft, a control stick for an aircraft, a stimuli-sensitive region of the display screen 1840, a voice-analyzing device that is operable to convert arrangements of audible frequencies into electrical signals, or an eye-movement tracking device that is operable to produce an electrical signal in response to a crewmember focusing on a particular region of the display screen 1840. Functionally, the user interface 1810 is operable to generate the first signal and the second signal that are sent to the processor 1820 in response to an action by the crewmember that is manipulating the user interface.

The memory 1830 is operable to store data or instructions that, when read by the processor 1820, cause the processor to perform steps that are in keeping with the example embodiment described above. These steps may be executed by the processor 1820 in response to receiving the first signal and the second signal that are generated by the user interface 1810, or alternatively in response to receiving the second signal that is generated by the user interface 1810.

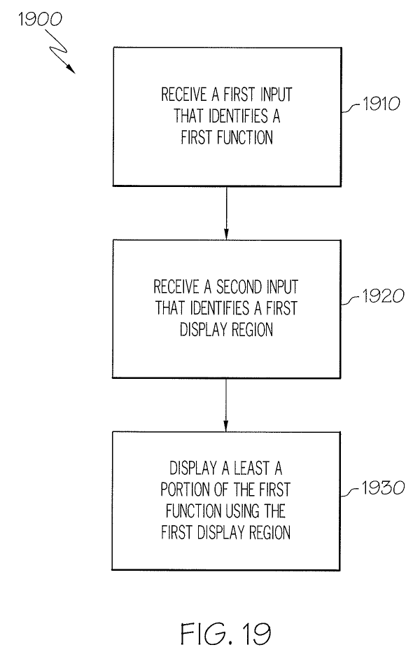

FIG. 19 is a flow diagram illustrating some processes included in a method 1900 of changing the appearance of a display screen in accordance with example embodiments, where the display screen includes a plurality of non-overlapping display regions. In some embodiments, the display screen may constitute part of a flight control deck.

Process 1910 includes receiving a first input that identifies a first function. According to example embodiments, the first function is a function that may be displayed on the display screen using at least one of the display regions of the display screen. According to some example embodiments, the first function may be any distinct function that is used for aircraft monitoring and control or aircraft sub-system monitoring and control.

Next, process 1920 includes receiving a second input that identifies a first display region. The identified first display region is one of the plurality of non-overlapping display regions that are included in the display screen.

Next, process 1930 is performed in response to receiving at least the first and second inputs. According to process 1930, at least a portion of the first function is displayed using the first display region of the display screen.

According to some example embodiments, the first display region is the only one of the plurality of non-overlapping display regions that is used to display the first function. This may occur, for example, when the first function is added to the display screen relative to a previous layout of the display screen that did not include the first function.

According to some other example embodiments, other display regions in addition to the first display region are used to display the first function. This may occur, for example, when the first function is expanded on the display screen relative to a previous layout of the display screen that displayed a smaller version of the first function.

While at least one example embodiment has been presented in the foregoing detailed description, it should be appreciated that a vast number of variations exist. It should also be appreciated that the example embodiment or example embodiments are not intended to limit the scope, applicability, or configuration of the invention in any way. Rather, the foregoing detailed description will provide those skilled in the art with a convenient road map for implementing the inventive aspects that may be found in at least one embodiment. The subject matter of the invention includes all combinations and subcombinations of the various elements, features, functions and/or properties disclosed in the example embodiments. It should be further understood that various changes can be made in the function and arrangement of elements without departing from the scope of the invention as set forth in the appended claims and the legal equivalents thereof.

1. A method for changing the appearance of a display screen, the display screen including a plurality of non-overlapping display regions, the method comprising the steps of:
receiving a first input that identifies a first function that can be displayed on the display screen;
receiving a second input that identifies a first display region of the plurality of non-overlapping display regions; and
displaying at least a portion of the first function using the first display region in response to receiving the first input and receiving the second input.

2. The method of claim 1, wherein displaying at least the portion of the first function using the first display region comprises displaying an entirety of the first function on the display screen using only the first display region.

3. The method of claim 1, further comprising, prior to receiving the second input, displaying the first function in at least a second display region of the plurality of non-overlapping display regions.

4. The method of claim 3, wherein displaying at least the portion of the first function using the first display region comprises expanding the first function such that the first display region defines a boundary of the first function.

5. The method of claim 4, wherein expanding the first function such that the first display region defines a boundary of the first function comprises expanding the first function such that a corner of the first function coincides with a corner of the first display region.

6. The method of claim 5, wherein the corner of the first display region comprises substantially ninety degrees.

7. The method of claim 6, wherein a perimeter of each of the plurality of non-overlapping display regions comprises four corners of substantially ninety degrees.

8. A system for displaying functions, the system comprising:
a display screen having a plurality of non-overlapping display regions;
a user interface; and
a processor that is coupled to the display screen and to the user interface, the processor operable to:
control the display screen such that a first function is generated in at least a first display region of the plurality of non-overlapping display regions,
receive a first signal generated by the user interface, the first signal indicative of a second function,
receive a second signal generated by the user interface, the second signal indicative of the first display region, and
control the display screen such that at least a portion of the second function is generated in the first display region in response to receiving at least the first signal and the second signal.

9. The system of claim 8, wherein controlling the display screen such that at least a portion of the second function is generated in the first display region comprises controlling the display screen such that an entirety of the second function is generated using only the first display region.

10. The system of claim 8, wherein controlling the display screen such that at least a portion of the second function is generated in the first display region comprises controlling the display screen such that the second function is generated in a first group of adjacent display regions that are selected from the plurality of non-overlapping display regions, the first group of adjacent display regions including the first display region, a perimeter of the first group of adjacent display regions having the same number of corners as the first display region.

11. The system of claim 10, wherein a corner of the first display region coincides with a corner of the perimeter of the first group of adjacent display regions.

12. The system of claim 11, wherein the corner of the perimeter of the first group of adjacent display regions coincides with a corner of the display screen.

13. The system of claim 11, wherein the processor is operable to select the first group of adjacent display regions such that a displayed size of the first function is maximized.

14. The system of claim 11, wherein the processor is operable to:
control the display screen such that the first function is displayed in a second group of adjacent display regions that are selected from the plurality of non-overlapping display regions, the second group of adjacent display regions including the first display region and a second display region that abuts the first group of adjacent display regions; and
in response to receiving at least the first signal and the second signal, control the display screen such that a third function is displayed in the second display region, the third function a default function for the second display region.

15. A processor-readable medium that, when read by one or more processors, causes the one or more processors to perform steps that comprise:
processing a first input that is indicative of a first display region of a display screen that includes a plurality of non-overlapping display regions that are arranged on the display screen;
processing a second input that is indicative of a first function of a plurality of functions that can be displayed on the display screen; and
based at least upon the processing of the first input and the second input, controlling the display screen such that at least a portion of the first function is displayed in the first display region.

16. The processor-readable medium of claim 15, wherein controlling the display screen comprises controlling the display screen such that the first function is displayed entirely in the first display region.

17. The processor-readable medium of claim 15, wherein controlling the display screen comprises:
selecting a first group of display regions from the plurality of non-overlapping display regions, the first group of display regions including the first display region, a perimeter of the first group of display regions having the same number of corners as the first display region; and
controlling the display screen such that the first function is displayed in the first group of display regions.

18. The processor-readable medium of claim 17 that, when read by the one or more processors, causes the one or more processors to perform steps further comprising:
prior to processing the first input, controlling the display screen such that a second function is displayed in a second group of display regions, the second group of display regions including the first display region, a perimeter of the second group of display regions having the same number of corners as the first display region;
based at least upon the processing of the first input and the second input, selecting a third group of display regions from the second group of display regions, a perimeter of the third group of display regions having the same number of corners as the first display region, the third group of display regions not including the first display region; and
controlling the display screen such that the second function is displayed in the third group of display regions, the third group of display regions selected in a manner that maximizes a display area of the second function.

19. The processor-readable medium of claim 18, the third group of display regions selected such that the display area of the second function is maximized in the horizontal direction.

20. The processor-readable medium of claim 19, wherein the third group of display regions consists of one display region.
